(19) United States
(12) Patent Application Publication
(10) Pub. No.: US 2014/0188425 A1
(43) Pub. Date: Jul. 3, 2014

(54) SYSTEM AND METHOD FOR SELECTING FANS FOR SERVER CABINET

(71) Applicant: HON HAI PRECISION INDUSTRY CO., LTD., New Taipei (TW)

(72) Inventors: CHENG-HSIU YANG, New Taipei (TW); CHIN-HUI CHEN, New Taipei (TW)

(73) Assignee: HON HAI PRECISION INDUSTRY CO., LTD., New Taipei (TW)

(21) Appl. No.: 14/141,467

(22) Filed: Dec. 27, 2013

(30) Foreign Application Priority Data
Dec. 28, 2012 (TW) 101151107

(51) Int. Cl. G01P 5/00

(52) U.S. Cl. CPC G01P 5/00
USPC 702/128

(57) ABSTRACT

A method for selecting fans for a server cabinet includes the following steps. First, a type of fan stored in a database is selected, and the parameters related to the fan of the selected type are compared to input parameters of a server cabinet. Second, a maximum quantity of the fan of the selected type that can be accommodated in the server cabinet is calculated. Third, an airflow of an initial quantity of the fan of the selected type is calculated when the initial quantity of the fan of the selected type is determined to be less than the maximum quantity. Fourth, the initial quantity of the fan of the selected type and the related parameters of the fan of the selected type are output to a display if the calculated airflow is determined to be greater than or equal to a minimum required airflow of the server cabinet.

### BACKGROUND

1. Technical Field

The present disclosure relates to a system and a method for selecting fans for a server cabinet, wherein both the system and the method can be implemented by using an electronic device such as a computer.

2. Description of Related Art

Server systems often include a number of standard servers arranged in server cabinets. The servers generate large amounts of heat, so fans may be mounted inside the server cabinets to dissipate the heat. However, if more fans are mounted inside the server cabinet than are required to dissipate the heat efficiently, the excess fans may waste large amounts of energy.

Therefore, what is needed is a system and a method for selecting fans for a server cabinet which can alleviate or even overcome the limitations described above.

### BRIEF DESCRIPTION OF THE DRAWINGS

The emphasis is placed upon clearly illustrating the principles of the present disclosure.

FIG. 1 is a block diagram of an electronic device, wherein the electronic device includes a system of an embodiment of the present invention, namely a system for selecting fans for a server cabinet.

FIG. 2 is a block diagram of the embodiment of the system for selecting fans for a server cabinet.

FIG. 3 is a schematic diagram of an embodiment of a user interface provided by the system of FIG. 2.

FIGS. 4A and 4B together constitute a flowchart of an embodiment of a method of the present invention, namely a method for selecting fans for a server cabinet.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.” The references “a plurality of” and “a number of” mean “at least two.”

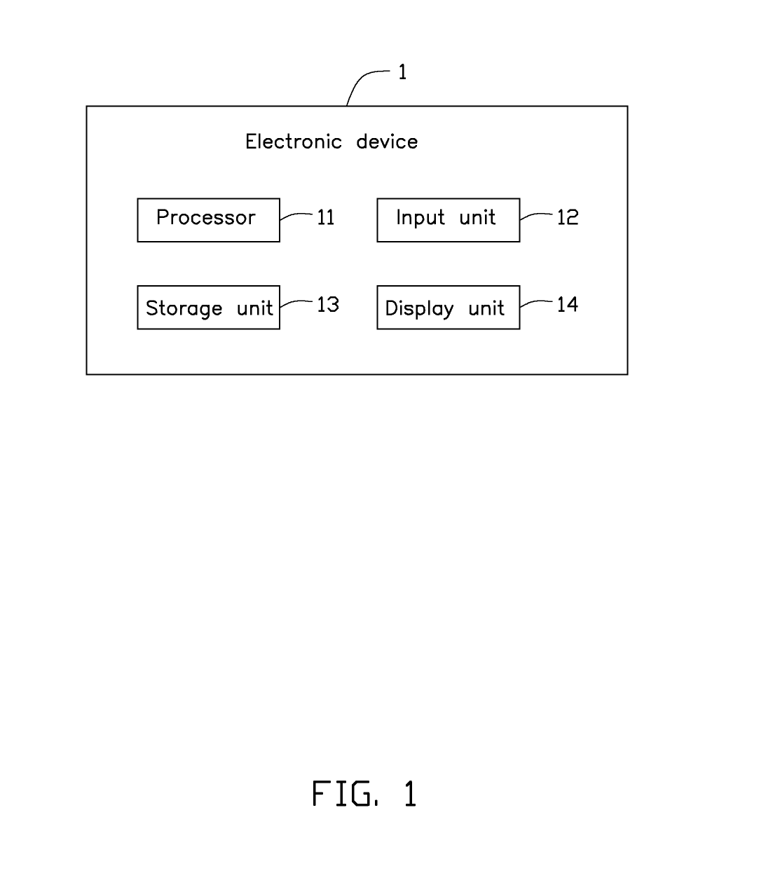

FIG. 1 is a block diagram of an embodiment of an electronic device 1. The electronic device 1 includes a processor 11, an input unit 12, a storage unit 13, and a display unit 14. The electronic device 1 can for example be a computer such as a personal computer.

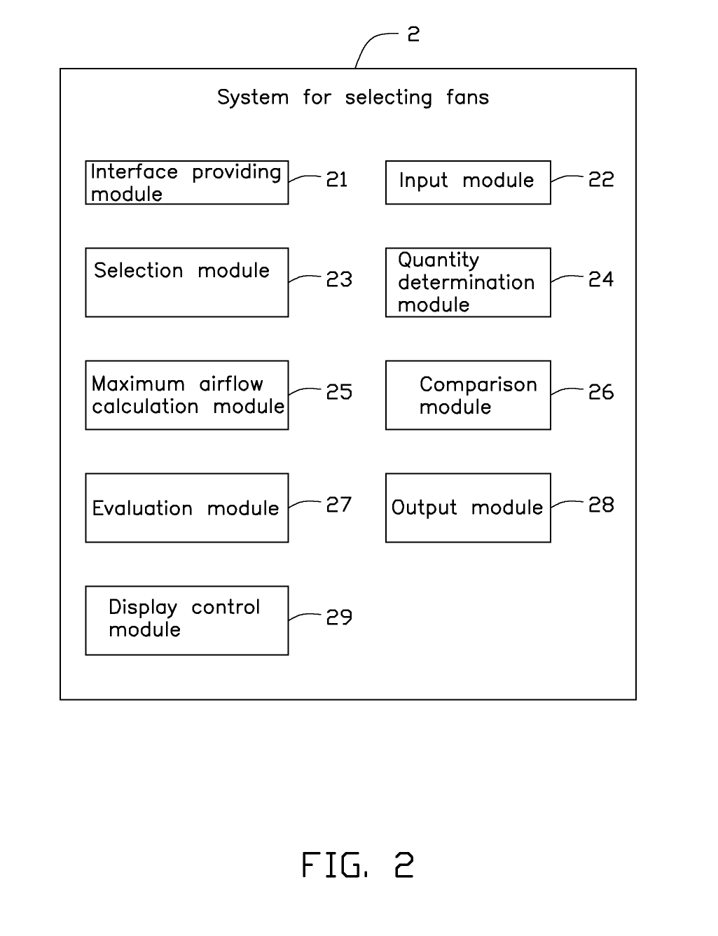

FIG. 2 is a block diagram of an embodiment of a system 2 for selecting fans for a server cabinet (hereinafter “the system 2”). The system 2 is installed and applied in the electronic device 1. In one embodiment, the system 2 is executed by the processor 11. Typically, the system 2 is configured for determining a needed quantity of one type of fan selected by a user or selected automatically, whereby such amount of fans can properly dissipate heat of a given server cabinet of interest to the user. In addition, more than one type of fan may be selected by the user (or selected automatically) in order to achieve the desired proper heat dissipation for the server cabinet of interest. In one embodiment, the processor 11 analyzes the fan type and determines the fan quantity by an analog calculation.

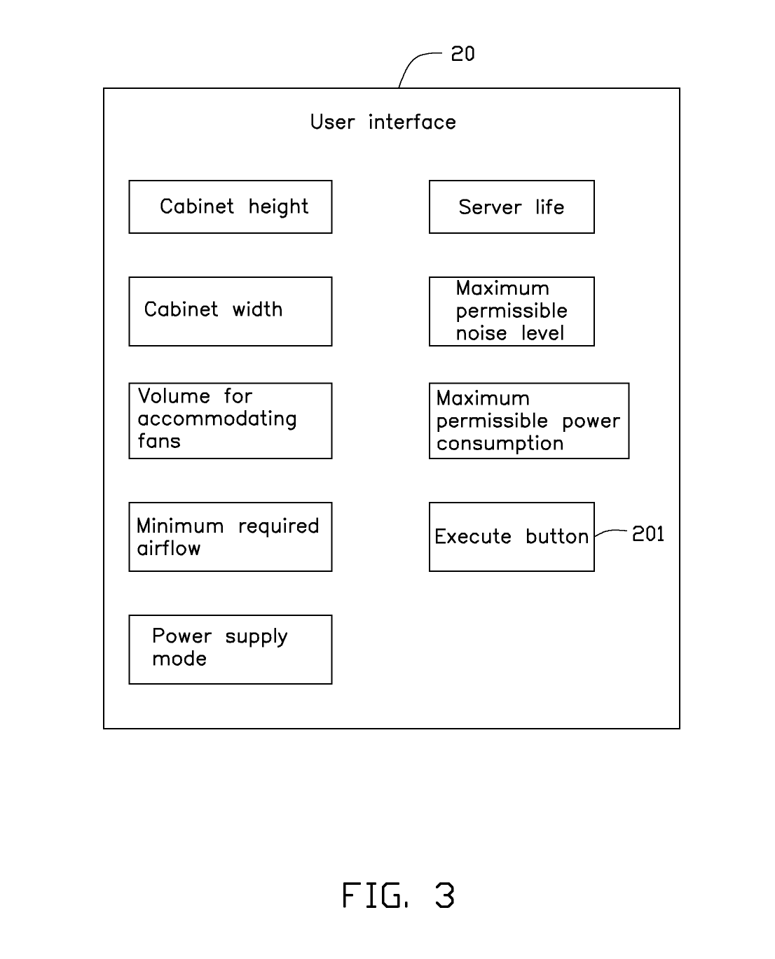

The system 2 includes an interface providing module 21, an input module 22, a selection module 23, a quantity determination module 24, a maximum airflow calculation module 25, a comparison module 26, an evaluation module 27, an output module 28, and a display control module 29. Referring also to FIG. 3, the interface providing module 21 is configured for providing a user interface 20 for a user. Typically, the user interface 20 is displayed on the display unit 14 of the electronic device 1. The input unit 12 of the electronic device 1 includes a touch screen overlaying the display unit 14. Thus the user interface 20 is operable by touch input by a user on the touch screen of the input unit 12. Further and/or alternatively, the input unit 12 can include a computer mouse.

The user interface 20 provides a number of input boxes for inputting known values of parameters of a cabinet such as a server cabinet. In this description, such known values are also referred to as “predefined parameters” of the server cabinet. In the illustrated embodiment, the parameters include a cabinet height, a cabinet width, a volume in the server cabinet available for accommodating fans, a minimum required airflow of the server cabinet, a server life of the server cabinet, a maximum permissible noise level of the server cabinet, and a maximum permissible power consumption of the server cabinet. The user interface 20 further includes a selection box for selecting a power supply mode for the server cabinet, and an execute button 201. In one embodiment, the power supply mode can be selected from one of a direct current power supply mode and an alternating current power supply mode.

The input module 22 is configured for storing the inputted values of parameters for the server cabinet in the storage unit 13 of the electronic device 1, in response to a manual operation of touching the execute button 201 or clicking on the execute button 201.

The storage unit 13 is configured for storing a database of values of parameters for a number of types of fans. In one embodiment, the parameters for each type of fan include a power supply mode, a three-dimensional size, a rotating speed, an airflow level, a noise level, a required voltage and current, a power consumption, a service life, and a cost.

The selection module 23 is configured for selecting a type of fan in the database in response to a selection operation applied on the input unit 12, and for obtaining the values of all the parameters related to the fan of the selected type from the storage unit 13.

The quantity determination module 24 is configured for calculating a maximum quantity of the fan of the selected type that can be accommodated in the server cabinet according to the volume of the server cabinet.

The quantity determination module 24 is further configured for setting an initial quantity of the fan of the selected type. In one embodiment, the initial quantity is a default value of the system 2. In an alternative embodiment, the value of the initial quantity is input by a user. The initial quantity is by definition required to be less than or the same as the maximum quantity of fans that can be accommodated in the server cabinet. If the quantity determination module 24 determines that the value of the initial quantity input by the user is greater than the maximum quantity, the quantity determination module 24 controls the display unit 14 to display a warning message and an input box for the user to input a new value of the initial quantity.

When the quantity determination module 24 determines that the initial quantity is less than or the same as the maximum quantity, the maximum airflow calculation module 25 calculates the maximum airflow that the initial quantity of the fan of the selected type generates. In one embodiment, the calculated maximum airflow is equal to the maximum airflow of one fan of the selected type multiplied by the initial quantity. For example, if the maximum airflow of one fan of the selected type is 100 cubic feet per minute (CFM), and the initial quantity is two, the calculated maximum airflow is 200 CFM.

The comparison module 26 is configured for comparing the calculated maximum airflow with the minimum required airflow of the server cabinet, and determining whether the calculated maximum airflow is greater than or equal to the minimum required airflow of the server cabinet.

If the comparison module 26 determines that the calculated maximum airflow is greater than or equal to the minimum required airflow of the server cabinet, the evaluation module 27 evaluates other parameters of the initial quantity of the fan of the selected type, such as power consumption and noise level, and determines whether the other parameters of the initial quantity of the fan of the selected type satisfy the corresponding predefined parameters of the server cabinet.

The output module 28 is configured for outputting the initial quantity of the fan of the selected type and all the parameters related to the fan of the selected type to the display unit 14, and for controlling the storage unit 13 to store the initial quantity of the fan of the selected type and all the parameters related to the fan of the selected type, when the other parameters of the initial quantity of the fan of the selected type satisfy the corresponding predefined parameters of the server cabinet.

The display control module 29 is configured for controlling the display unit 14 to display the initial quantity of the fan of the selected type and all the parameters related to the initial quantity of the fan of the selected type.

If the comparison module 26 determines that the calculated maximum airflow of the initial quantity of the fan of the selected type is less than the minimum required airflow of the server cabinet, the quantity determination module 24 determines whether the initial quantity is less than the maximum quantity. If the initial quantity is less than the maximum quantity, the quantity determination module 24 increases the initial quantity by one to obtain a new initial quantity. On the other hand, if the initial quantity is the same as the maximum quantity, the selection module 23 determines whether there are any other types of fans in the database which have not yet been selected.

The maximum airflow calculation module 25 is further configured for calculating the maximum airflow that the new initial quantity of the fan of the selected type generates.

The comparison module 26 is further configured for comparing the calculated maximum airflow of the new initial quantity with the minimum required airflow of the server cabinet, and determining whether the calculated maximum airflow is greater than or equal to the minimum required airflow of the server cabinet. If the calculated maximum airflow is less than the minimum required airflow, the quantity determination module 24 determines whether the new initial quantity is less than the maximum quantity. If the new initial quantity is less than the maximum quantity, the quantity determination module 24 increases the new initial quantity by one to obtain a further new initial quantity. On the other hand, if the new initial quantity is the same as the maximum quantity, the selection module 23 determines whether there are any other types of fans in the database which have not yet been selected.

When the selection module 23 determines that there are one or more other types of fans in the database which have not yet been selected, the selection module 23 selects another type of fan and obtains all the parameters related to the newly selected type of fan, by repeating the above-described processes. Otherwise, the output module 28 outputs all the parameters related to the type of fan already selected to the display unit 14, and the process ends. In one embodiment, the output module 28 outputs all the parameters related to the type of fan already selected to the display unit 14 as a spreadsheet

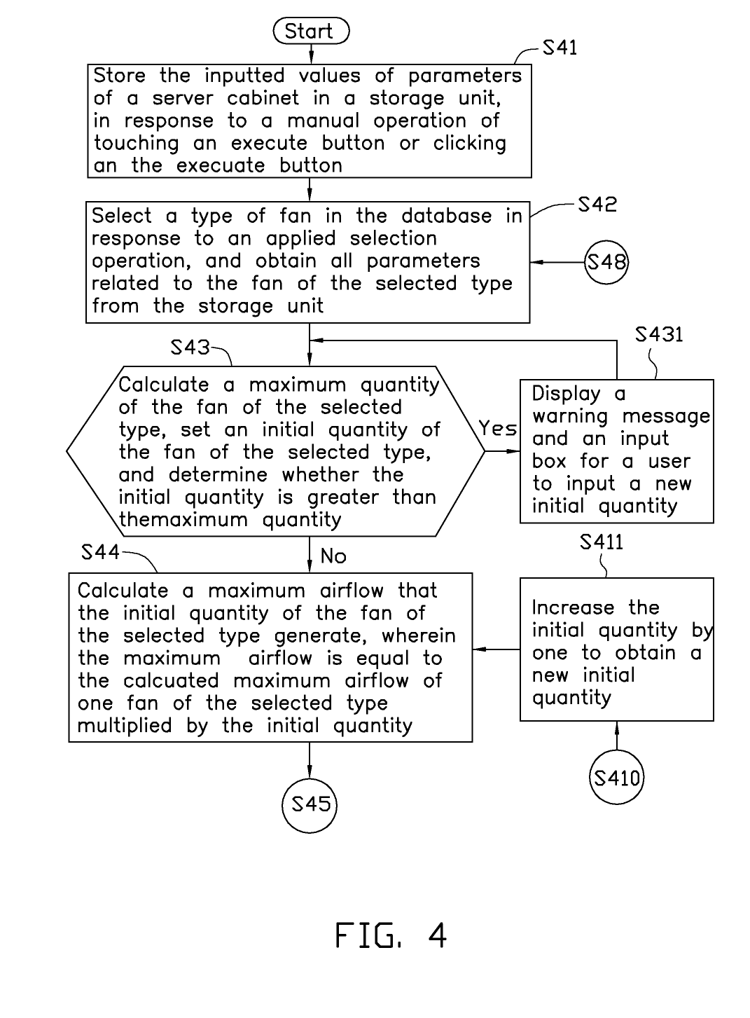

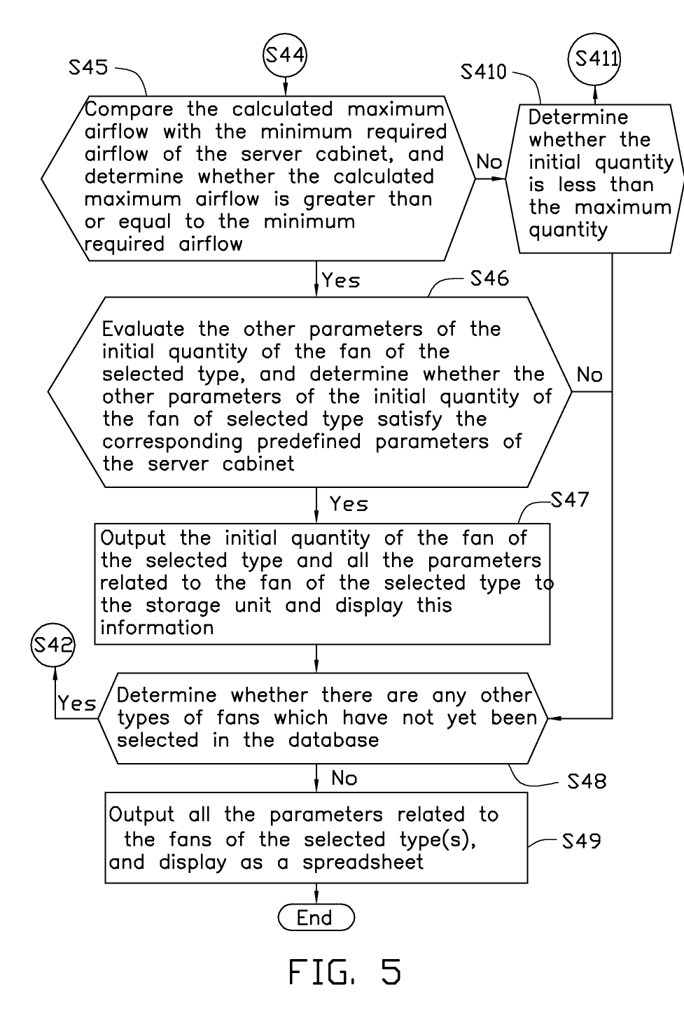

FIGS. 4 and 5 together constitute a flowchart of a method for selecting fans for a server cabinet. The method can be applied in the electronic device 1. The method includes the following steps, each of which is related to the various components Contained in the electronic device 1.

In step S41, the input selection module 22 stores inputted values of parameters of the server cabinet in the storage unit 13, in response to a manual operation of touching the execute button 201 or clicking on the execute button 201.

In step S42, the selection module 23 selects a type of fan in the database in response to an applied selection operation, and obtains all parameters related to the fan of the selected type from the storage unit 13.

In step S43, the quantity determination module 24 calculates a maximum quantity of the fan of the selected type that can be accommodated in the server cabinet according to the volume of the server cabinet, sets an initial quantity of the fan of the selected type, and determines whether the initial quantity is greater than the maximum quantity. If the determination is yes, the process goes to step S431. If the determination is no, the process goes to step S44.

In step S431, the quantity determination module 24 controls the display unit 14 to display a warning message and an input box for the user to input a new value of the initial quantity. Then the process returns to step S43.

In step S44, the maximum airflow calculation module 25 calculates a maximum airflow that the initial quantity of the fan of the selected type generates. In the embodiment, the calculated maximum airflow is equal to the maximum airflow of one fan of the selected type multiplied by the initial quantity.

In step S45, the comparison module 26 compares the calculated maximum airflow with the minimum required airflow of the server cabinet, and determines whether the calculated maximum airflow is greater than or equal to the minimum required airflow of the server cabinet. If the determination is yes, the process goes to step S46. If the determination is no, the process goes to step S410.

In step S46, the evaluation module 27 evaluates the other parameters of the initial quantity of the fan of the selected type, and determines whether the other parameters of the initial quantity of the fan of the selected type satisfy the corresponding predefined parameters of the server cabinet. If the determination is yes, the process goes to step S47, if the determination is no, the process goes to step S48.

In step S47, the output unit 28 outputs the initial quantity of the fan of the selected type and all the parameters related to the fan of the selected type to the storage unit 13, for the storage unit 13 to store all such information. The display control unit 210 controls the display unit 14 to display the initial quantity of the fan of the selected type and all the parameters related to the fan of the selected type.

In step S48, the selection module 23 determines whether there are any other types of fans in the database which have not yet been selected. If the determination is yes, the process goes back to step S42. If the determination is no, the process goes to step S49.

In step S49, the output module 28 outputs all the parameters related to the fans of the selected type(s) to the display unit 14, for display on the display unit 14. In one embodiment, all the information is displayed as a spreadsheet. Then the process ends.

In step S410, the quantity determination module 24 determines whether the initial quantity is less than the maximum quantity. If the determination is yes, the process goes to step S411. If the determination is no (i.e., the initial quantity is equal to the maximum quantity), the process goes to step S48.

In step S411, the quantity determination module 24 increases the initial quantity by one to obtain a new initial quantity, and the process goes back to step S44.

Although various embodiments have been specifically described, the disclosure is not to be construed as being limited thereto. Various changes or modifications may be made to the embodiments without departing from the scope and spirit of the disclosure.

What is claimed is:

1. A method for selecting fans for a server cabinet, the method executable in an electronic device having a storage unit, the storage unit having stored therein a database of values of parameters for a plurality of types of fans, the method comprising:
selecting a type of fan in the database, and obtaining values of parameters related to the fan of the selected type from the storage unit;
calculating a maximum quantity of the fan of the selected type that can be accommodated in the server cabinet, setting an initial quantity of the fan of the selected type, and determining whether the initial quantity is less than or equal to the maximum quantity;
calculating a maximum airflow that the initial quantity of the fan of the selected type generates when the initial quantity is less than or equal to the maximum quantity;
comparing the calculated maximum airflow with a minimum required airflow of the server cabinet; and
outputting the initial quantity of the fan of the selected type when the calculated maximum airflow is greater than or equal to the minimum required airflow.

2. The method as described in claim 1, wherein before selecting a type of fan in the database and obtaining parameters related to the selected type of the fan from the storage unit, the method further comprises:
providing a user interface which including an execute button; and
storing parameters inputted via the user interface in response to a manual operation of touching the execute button or clicking the execute button.

3. The method as described in claim 1, further comprising:
when the initial quantity is greater than the maximum quantity, displaying a warning message and an input box for a user to input a new value of the initial quantity.

4. The method as described in claim 1, further comprising:
when the calculated maximum airflow of the initial quantity of the fan of the selected type is less than the minimum required airflow of the server cabinet, determining whether the initial quantity is less than the maximum quantity; and
increasing the initial quantity by one to obtain a new initial quantity when the initial quantity is less than the maximum quantity.

5. The method as described in claim 1, wherein before outputting and storing the initial quantity of the fan of the selected type and parameters related to the fan of the selected type therein, the method comprises:
determining whether other parameters of the initial quantity of the fan of the selected type satisfy corresponding parameters of the server cabinet; and
outputting the initial quantity of the fan of the selected type and parameters related to the fan of the selected type and storing the initial quantity of the fan of the selected type and all parameters related to the fan of the selected type therein when the other parameters of the initial quantity of the fan of the selected type satisfy corresponding parameters of the server cabinet.

6. A system for selecting fans for a server cabinet, the system comprising:
a storage unit including a database of values of parameters for a plurality of types of fans;
a selection module, configured for selecting a type of fan stored in the database and obtaining values of parameters related to the fan of the selected type from the storage unit;
a quantity determination module, configured for calculating a maximum quantity of the fan of the selected type capable of being accommodated in the server cabinet, setting an initial quantity of the fan of the selected type, and determining whether the initial quantity is less than or equal to the maximum quantity;
a maximum airflow calculation module, configured for calculating a maximum airflow that the initial quantity of the fan of the selected type generates when the initial quantity is less than or equal to the maximum quantity;
a comparison module, configured for comparing the calculated maximum airflow with a minimum required airflow of the server cabinet; and
an output module, configured for outputting the initial quantity of the fan of the selected type when the calculated maximum airflow is greater than or equal to the minimum required airflow.

7. The system as described in claim 6, further comprising:
an interface providing module, configured for providing a user interface which including an execute button; and
an input module, configured for controlling a storage unit to store parameters displayed on the user interface in response to a manual operation of touching the execute button or clicking the execute button.

8. The system as described in claim 6, wherein the quantity determination module is configured for controlling a display unit to display a message and an input box for a user to input a new initial quantity when determined that the initial quantity is greater than the maximum quantity.

9. The system as described in claim 6, wherein when the comparison module determines that the calculated maximum airflow of the initial quantity of the fan of the selected type is less than the minimum required airflow of the server cabinet, the quantity determination module is further configured for determining whether the initial quantity is less than the maximum quantity and further determining that the initial quantity is increasing by one to obtain a new quantity when the initial quantity is less than the maximum quantity.

10. The system as described in claim 6, further comprising an evaluation module, which is configured for determining whether other parameters of the fan of the selected type satisfy corresponding parameters of the server cabinet; wherein the output module is further configured for outputting the initial quantity of the fan of the selected type when the other parameters of the fan of the selected type satisfy corresponding parameters of the server cabinet.
